(19) United States
(12) Patent Application Publication
(10) Pub. No.: US 2024/0418561 A1
(43) Pub. Date: Dec. 19, 2024

(54) WEIGHT SCALE WITH REVERSIBLE DISPLAY

(71) Applicant: CONAIR LLC, Stamford, CT (US)

(72) Inventors: Christiane HORMANN, Norwalk, CT (US); Vito James CARLUCCI, Stratford, CT (US)

(73) Assignee: CONAIR LLC, Stamford, CT (US)

(21) Appl. No.: 18/742,736

(22) Filed: Jun. 13, 2024

Related U.S. Application Data
(60) Provisional application No. 63/508,374, filed on Jun. 15, 2023.

(51) Int. Cl. G01G 19/44

(52) U.S. Cl. CPC G01G 19/44

(57) ABSTRACT

A weight scale includes a platform and a display connected to the platform. The display is controllable to display information in more than one orientation. A method for a weight scale includes, if information is in a first orientation on a display of the weight scale, then displaying the information so it is inverted from the first orientation to a second orientation on the display, or, if the information is in the second orientation on the display, then displaying the information so that it is inverted from the second orientation to the first orientation on the display.

### CROSS REFERENCE TO RELATED APPLICATIONS

This application claims the benefit of U.S. Application 63/508,374 filed Jun. 15, 2023, the contents of which are incorporated by reference herein.

### BACKGROUND

### 1. Field of the Disclosure

The present disclosure relates to a weight scale. In particular, the present disclosure relates to a weight scale that displays information in more than one orientation.

### 2. Description of Related Art

Conventional weight scales include a platform for people to stand on and a display. The display of the weight scale displays information such as the weight of a person standing on the platform. The information is displayed on the display in a single orientation for a person standing on the weight scale to read. The single orientation makes it a challenge for people other than the person standing on the weight scale to read the information displayed.

Accordingly, it has been determined by the present disclosure that there is a continuing need for a device that overcomes, alleviates, and/or mitigates one or more of the aforementioned and other deleterious effects of prior devices.

### SUMMARY

The present disclosure provides a weight scale having a display that displays information in more than one orientation.

Advantageously, the display of the weight scale displays information in a vertical orientation that can be toggled so that in a first orientation the information is right-side-up for viewing by the person standing on the scale, and in a second orientation the information is flipped 180 degrees so that a caregiver or person other than the person standing on the scale can read the information with proper orientation.

The above-described and other features and advantages of the present disclosure will be appreciated and understood by those skilled in the art from the following detailed description, drawings, and appended claims.

### DESCRIPTION OF THE DRAWINGS

FIG. 1 is a top view of a weight scale according to the present disclosure.

FIG. 2 is a schematic top view of a weight scale according to the present disclosure.

FIG. 3A is a schematic top view of a display of the weight scale of FIG. 2 displaying information in a first orientation.

FIG. 3B is a schematic top view of the display of the weight scale of FIG. 2 displaying information in a second orientation.

FIG. 4 is a bottom view of the weight scale of FIG. 2.

FIG. 5 is a front view of the weight scale of FIG. 2.

FIG. 6 is a side view of the weight scale of FIG. 2.

FIG. 7 is a top perspective view of the weight scale of FIG. 1 displaying information in the first orientation with a user on the weight scale.

FIG. 8 is a top perspective view of the weight scale of FIG. 1 displaying information in the second orientation and a second person.

FIG. 9 is an enlarged partial view of the weight scale of FIG. 1 having information displayed in the first orientation.

FIG. 10 is an enlarged partial view of the weight scale of FIG. 1 having the information displayed in the first orientation and a button being pushed.

FIG. 11 is an enlarged partial view of the weight scale of FIG. 1 having the information displayed in the second orientation and the button being pushed.

FIG. 12 is a diagram of a method that can be used with the weight scale of FIG. 1.

FIG. 13 is an operation flow chart of the weight scale of FIG. 1.

### DETAILED DESCRIPTION

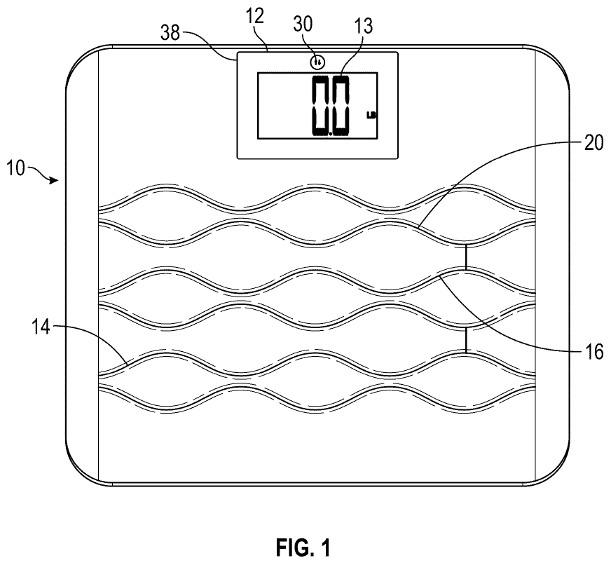

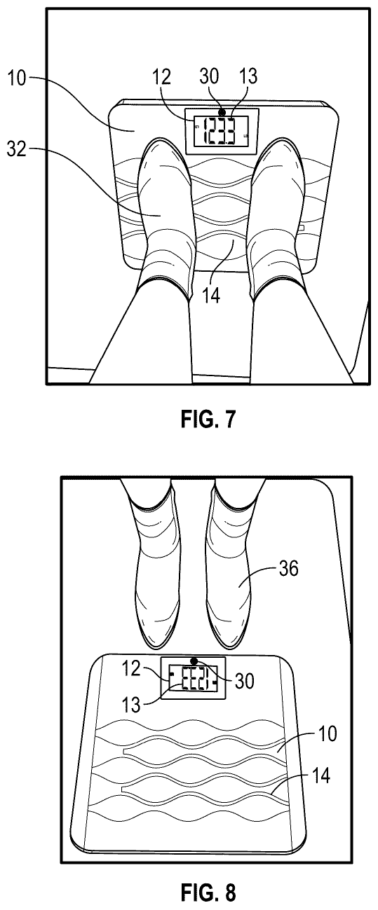

Referring to the drawings and in particular to FIG. 1, an exemplary embodiment of a weight scale according to the present disclosure is shown and is generally referred to by reference numeral 10. When a user stands on weight scale 10, weight scale 10 measures one or more characteristics of the user, for example, one or more of (not limited to) weight, body fat, body water, bone mass, muscle mass, BMI, heart rate, and/or other measurements/calculations as are known in the art. Weight scale 10 has a display 12 to display information 13 relating to the one or more characteristics measured. Advantageously, weight scale 10 displays information 13 on display 12 in a vertical orientation that can be toggled so that in a first orientation, as shown in FIGS. 3A and 7, information 13 is right-side-up for viewing by the person or user 32 standing on the scale, and in a second orientation information 13 is flipped 180 degrees, as shown in FIGS. 3B and 8, so that a caregiver or second person 36 other than the person standing on the scale can read the information with proper orientation.

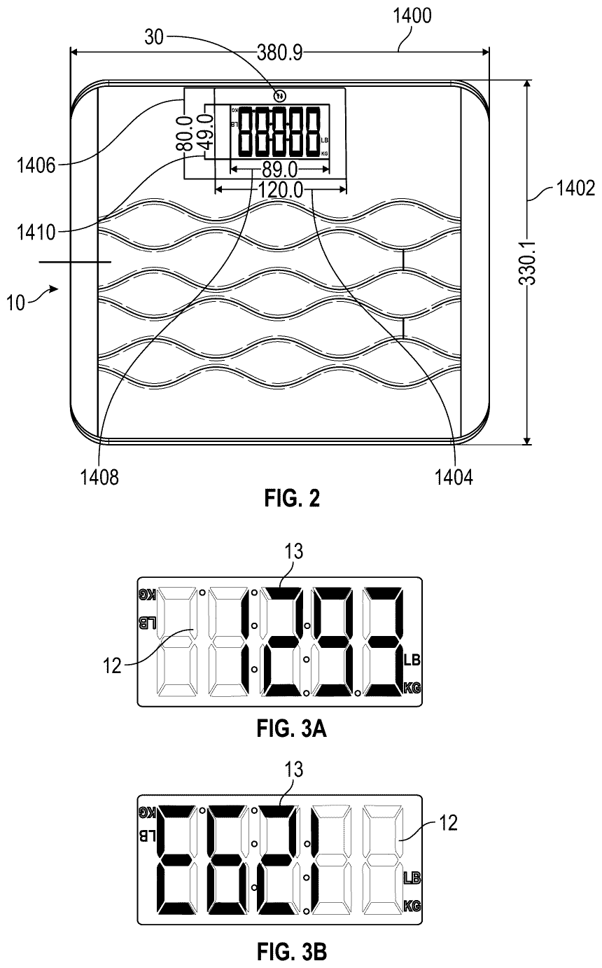

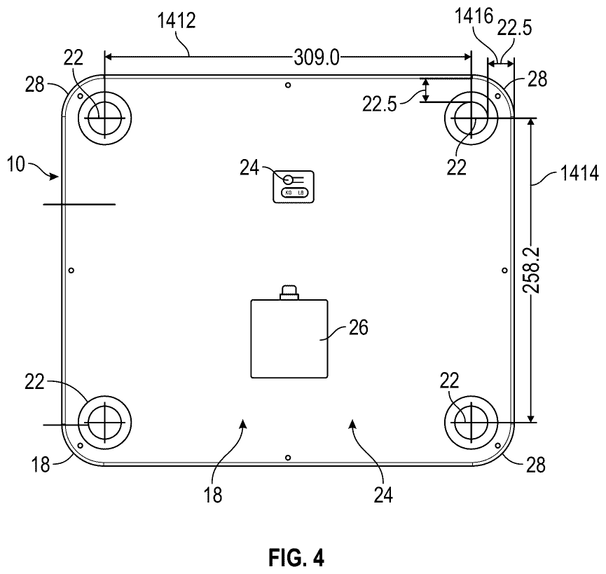

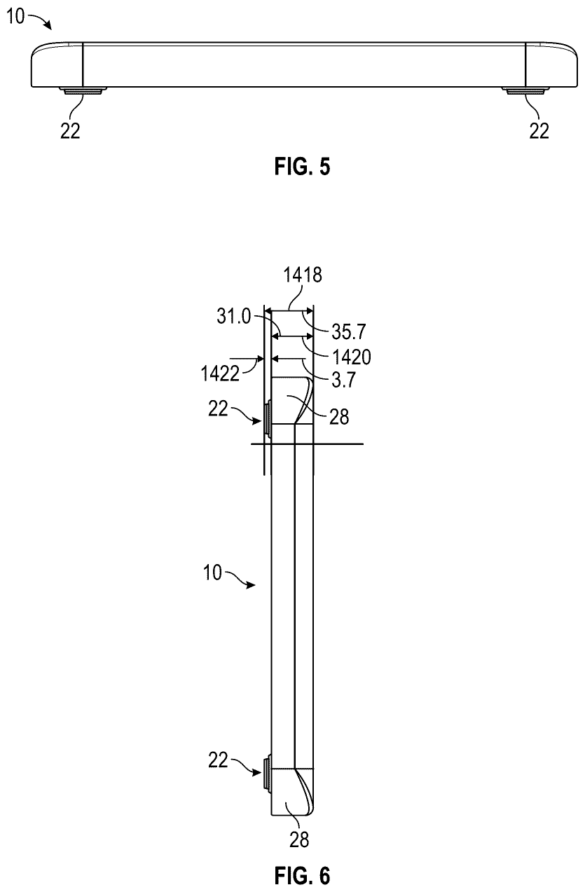

Referring to FIGS. 1 and 2, weight scale 10 has a platform 14 connected to display 12. Platform 14 can include a top cover 16 made from acrylonitrile butadiene styrene (“ABS”) and a bottom cover 18, as shown in FIGS. 4-6, that is made of high impact polystyrene (“HIPS”). Referring back to FIGS. 1 and 2, top cover 16 can include a texture 20. As shown in FIG. 4, bottom cover 18 has feet 22 that can be rubber or plastic and a bottom cover button 24. A battery cover 26 is removably connected to bottom cover 18. Corner covers 28 are connected to top cover 16 and bottom cover 18.

Display 12 can include, for example, a liquid crystal display (LCD) with blue backlight or light emitting diode (“LED”) display and be covered by 6 millimeter (“mm”) tempered glass. Weight scale 10 includes a top button 30. Top button 30 can be, for example, displayed on a touch screen or a mechanical button. Top button 30 is shown in FIGS. 1 and 2 as located above display 12, however, top button 30 could alternatively be located elsewhere on the weight scale 10. A further alternative includes replacing top button 30 with anyone of: voice activation, remote control, activated by app in a connected scale, or based on a timer function on timed intervals, e.g. every 10 seconds, or another alternative.

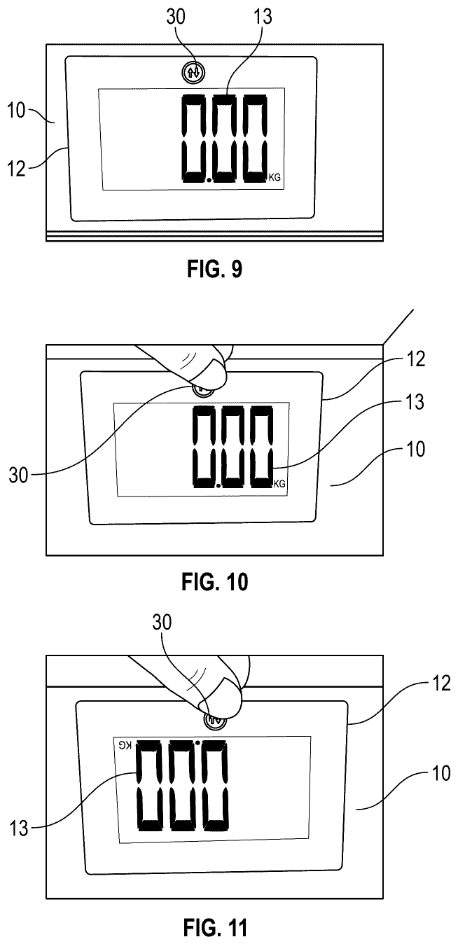

Referring to FIG. 7, during use, a user 32 activates weight scale 10, for example, either by stepping on platform 14 for a “step on” scale, or by tapping platform 14 for a “tap on” scale. Weight scale 10 measures one or more characteristics of user 32 when user 32 stands on weight scale 10. The one or more characteristics include, but are not limited to weight, body fat, body water, bone mass, muscle mass, BMI, heart rate, and/or other measurements/calculations as are known in the art. Weight scale 10 displays information 13 of the one or more characteristics on display 12, as shown in FIGS. 7 and 9, in the first orientation. The first orientation allows viewing by user 32. If desired, user 32 or, as shown in FIG. 8, a second person 36 that is not standing on weight scale for example, a caregiver, can press top button 30, as shown in FIG. 10, to flip or invert information 13 displayed on display 12 from the first orientation, as shown in FIGS. 3A, 7 and 9, so that display 12 displays information 13 in the second orientation, as shown in FIGS. 3B, 8 and 11. The second orientation allows for easier viewing by second person 36. User 32 or second person 36 can then press top button 30 to flip or invert information 13 displayed on display 12 from the second orientation, as shown in FIGS. 3B, 8 and 11, so that display 12 displays information 13 in the first orientation, as shown in FIGS. 3A, 7 and 9, or user 32 can step off weight scale 10.

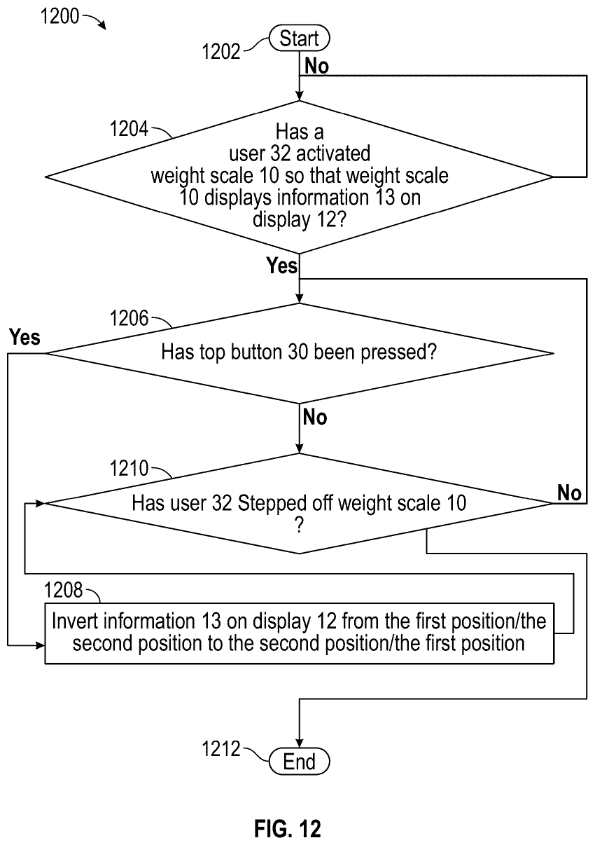

Referring to FIG. 12, a method 1200 can be used with weight scale 10. Method 1200 starts at step 1202 and proceeds to step 1204. In step 1204, it is determined if a user 32 activated weight scale 10 so that weight scale 10 displays information 13 on display 12. If it is determined that a user 32 has not activated weight scale 10 so that weight scale 10 displays information 13 on display 12, then method 1200 repeats step 1204. If it is determined that a user 32 has activated weight scale 10 so that weight scale 10 displays information 13 on display 12, then method 1200 proceeds to step 1206. In step 1206, it is determined if top button 30 has been pressed. If top button 30 has not been pressed, then method 1200 repeats step 1206. If top button 30 has been pressed, then method 1200 proceeds to step 1208. In step 1208, if information 13 is in the first orientation on display 12, then information 13 is inverted from the first orientation to be displayed on display 12 in the second orientation, and, if information 13 is in the second orientation on display 12, then information is inverted from the second orientation to be displayed on display 12 in the first orientation and proceeds to step 1210. In step 1210, it is determined if user 32 stepped off weight scale 10. If user 32 did not step off weight scale 10, then method 1200 repeats step 1206. If user 32 did step off weight scale 10, then method 1200 proceeds to step 1212 where method 1200 ends and display 12 no longer displays information 13. Alternatively, when it is determined that user 32 stepped off weight scale 10 in step 1210, display 12 can continue to display information 13 for a predetermined time and method 1200 can continue for the predetermined time to invert information 13 on display 12 when top button 30 is pressed and after the predetermined time has expired then method 1200 ends. Weight scale 10 can have a controller 38, for example, that includes a processor and memory, that can execute method 1200. Controller 38 can also, for example, receive input from a user interface including top button 30 when controlling display 12.

During use, weight scale 10 can be placed on the floor, for example, a wood or tile floor. In addition, during use, user 32 can limit movement while on weight scale 10. User 32 can press bottom cover button 24 on bottom cover 18 while weight scale 10 is activated for measuring in kilograms (kg) or pounds (lb.). Weight scale 10 can also have a speaker-icon button that can be pressed on bottom cover 18 to select a speaking mode, for example, to select between English, Spanish or None (Mute).

Weight scale 10 advantageously can display one or more (not limited to) characteristics, such as weight, body fat, body water, bone mass, muscle mass, BMI, heart rate, and other measurements/calculations as are known in the art on display 12 that is a reversible display, making it easy for a healthcare professional or caregiver standing on the other side of weight scale 10 to read the measurements. The user can change the direction of the display 12 (“standard mode” or “inverted/caregiver mode”) by push of a button, namely, top button 30. Alternatively, top button 30 can be replaced to invert information 13 on display 12 by other means, for example, voice activated, remote controlled, activated by app in a connected scale, or based on a timer that inverts at timed intervals, e.g. every 10 seconds, or other alternatives.

Referring to FIG. 2, weight scale 10 can have a width 1400, for example, of 380.9 mm, and a length 1402, for example, of 330.1 mm. Display 12 can have a width 1404, for example, of 120.0 mm, and a length 1406, for example, of 90.0 mm. Information 13 can have a width 1408, for example, of 89.0 mm, and a length 1410, for example, of 49.0 mm. Referring to FIG. 4, a distance 1412 between the center of top two feet 22 can be, for example, of 309.0 mm, and a distance 1414 between a center of side two feet 22 can be, for example, of 258.2 mm. A distance 1416 from the center of one of feet 22 to an edge of weight scale 10 can be, for example, of 22.5 mm. Referring to FIG. 6, weight scale 10 can have a height 1418, for example, of 35.7 mm. Corner covers 28 can have a height 1420, for example, of 31.0 mm. Feet 22 can have a height 1422, for example, of 3.7 mm. It is understood that these dimensions can have some amount of variation, but nonetheless these are the substantially the dimensions.

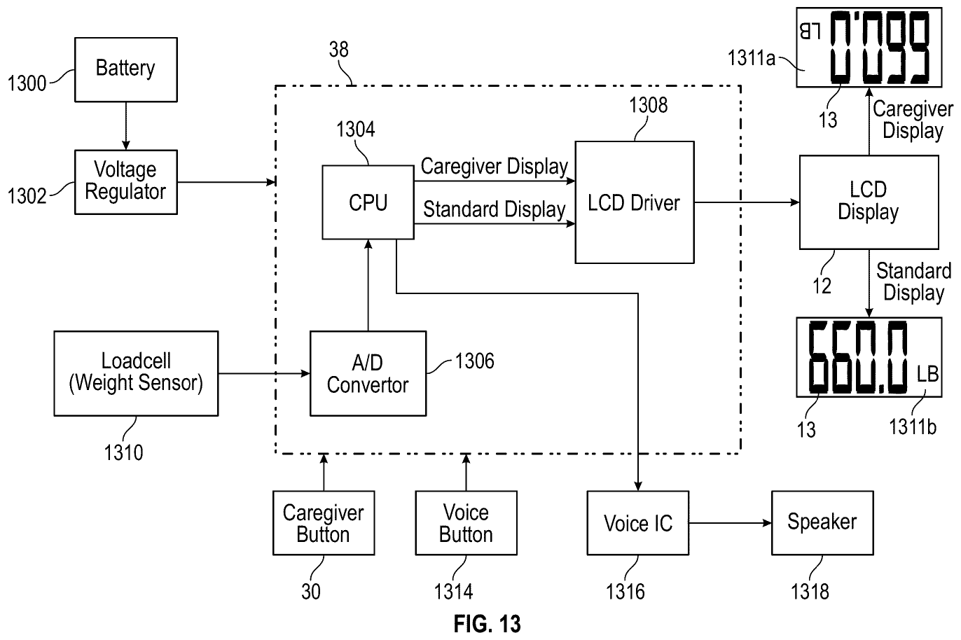

Referring to FIG. 13, an example of the operation of weight scale 10 can include a rechargeable battery 1300 that provides electric current to a voltage regulator 1302. Voltage regulator 1302 conducts electric current from rechargeable battery 1300 to controller 38 that has a central processing unit (“CPU”) 1304, analog-to-digital (“A/D”) convertor 1306, and LCD driver 1308. When user 32 steps on platform 14 of weight scale 10, a loadcell 1310 detects a value indicative of a weight of user 32 and communicates a loadcell output to A/D convertor 1306 based upon the value indicative of the weight of user 32. A/D convertor 1306 then communicates a converter output to CPU 1304 based upon the loadcell output from loadcell 1310 that is indicative of the weight of user 32, however, one or more other characteristics could alternatively or additionally be detected and communicated to CPU 1304 that include, but are not limited to body fat, body water, bone mass, muscle mass, BMI, heart rate, and/or other measurements/calculations as are known in the art. CPU 1304 communicates a CPU output to LCD driver 1308 that is indicative of the weight of user 32 as well as indicative of whether the weight should be displayed in the first orientation, as shown by 1311b in FIG. 13 and in FIGS. 3A and 7, with information 13 that is right-side-up for viewing by user 32 standing on weight scale 10, or in the second orientation of information 13 that is flipped 180 degrees, as shown by 1311a in FIG. 13 and in FIGS. 3B and 8, so that second person 36 other than the person standing on the scale can read information 13 with proper orientation. LCD driver 1308 controls display 12 to display the weight of user 32 in the first or second orientation based on the CPU output communicated to LCD driver 1308 by CPU 1304.

While the weight is displayed by display 12, user 32 or caregiver 36 can contact top button 30 to provide an input to controller 38 so that if information 13 is in the first orientation as shown by 1311b on display 12, then CPU 1304 communicates a CPU output to LCD driver 1308 to control display 12 to display information 13 in the second orientation as shown by 1311a, and, if information 13 is in the second orientation on display 12, then CPU 1304 communicates a CPU output to LCD driver 1308 to control display 12 to display information 13 in the first orientation as shown by 1311b. Accordingly, controller 38 can implement method 1200 as shown in FIG. 12.

Weight scale 10 can also have a voice button 1314. After user 32 steps on weight scale 10, loadcell 1310 detects the value indicative of the weight of user 32 and communicates the loadcell output to A/D convertor 1306 based upon the value indicative of the weight of user 32, and A/D convertor 1306 communicates the converter output to CPU 1304 based upon the loadcell output from loadcell 1310 that is indicative of the weight of user 32, a user can selectively contact voice button 1314 either before use or during use so that CPU 1304 communicates a voice output to a voice IC 1316 that is indicative of the weight of user 32. Voice IC 1316 then controls speaker 1318 to generate an audio sound indicative of the weight of user 32.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes can be made and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure should not be limited to the particular embodiment(s) disclosed as the best mode contemplated, but that the disclosure will include all embodiments falling within the scope of the appended claims.

What is claimed is:

1. A weight scale comprising:
a platform; and
a display connected to the platform, the display being controllable to display information in more than one orientation.

2. The weight scale of claim 1, wherein the information is a weight.

3. The weight scale of claim 1, wherein the information is selected from the group consisting of body fat, body water, bone mass, muscle mass, BMI, heart rate, and any combination thereof.

4. The weight scale of claim 1, wherein the display displays the information in a first orientation or a second orientation that is rotated 180 degrees from the first orientation.

5. The weight scale of claim 4, further comprising a button on the platform or display that selectively changes display of the information between the first orientation and the second orientation.

6. The weight scale of claim 1, wherein the platform has a top cover connected to a bottom cover.

7. The weight scale of claim 6, wherein the platform has corner covers connected to the top cover and the bottom cover.

8. The weight scale of claim 1, wherein the display is a liquid crystal display (LCD) or light emitting diode display.

9. The weight scale of claim 5, wherein the button is displayed on a touch screen or a mechanical button.

10. The weight scale of claim 5, wherein the button is above the display.

11. The weight scale of claim 4, further comprising a mechanism that selectively changes display of the information between the first orientation and the second orientation that is selected from the group consisting of voice activation, remote control, activated by app in a connected scale, based on a timer function on timed intervals, and any combinations thereof.

12. The weight scale of claim 1, wherein the display is connected to the platform on a first side that is opposite a second side of the platform, wherein the display displays the information in the first orientation that shows the information to be viewed from the second side to the first side and the display displays the information in the second orientation to be viewed from the first side to the second side.

13. The weight scale of claim 1, further comprising a loadcell to detect a value indicative of a weight of user and a controller having a CPU, an A/D convertor, and a LCD driver to control the display.

14. A method for a weight scale comprising:
if information is in a first orientation on a display of the weight scale, then displaying the information so it is inverted from the first orientation to a second orientation on the display, or, if the information is in the second orientation on the display, then displaying the information so that it is inverted from the second orientation to the first orientation on the display.

15. The method of claim 14, further comprising determining if a weight scale is activated so that weight scale displays information on the display prior to the displaying.

16. The method of claim 14, further comprising determining if a button has been pressed prior to the displaying.
